(19) United States
(12) Patent Application Publication
(10) Pub. No.: US 2007/0157507 A1
(43) Pub. Date: Jul. 12, 2007

(54) Method of controlling termites

(76) Inventors: Byron L. Reid, Raleigh, NC (US); Nicholas M. Hamon, Chapel Hill, NC (US); Brian L. Tepper, San Diego, CA (US)

Correspondence Address: BAYER CROPSCIENCE LP;Patent Department, 100 BAYER ROAD, PITTSBURGH, PA, 15205-9741, US

(21) Appl. No.: 11/654,325

(22) Filed: Jan. 17, 2007

Related U.S. Application Data
(63) Continuation-in-part of application No. PCT/US05/29859, filed on Aug. 22, 2005.
(60) Provisional application No. 60/603,963, filed on Aug. 25, 2004.

(30) Foreign Application Priority Data
Apr. 6, 2006 (WO) 2006/036387

(51) Int. Cl. A01M 1/20; A01M 17/00

(52) U.S. Cl. 43/132.1

(57) ABSTRACT

A method for controlling termites comprising applying at a locus a particulate termiticidal composition in the substantial absence of water.

### RELATED APPLICATIONS

This application is a continuation-in-part of International Application No. PCT/US2005/029859, filed Aug. 22, 2005, which was published in English as International Patent Publication WO 2006/036387 on Apr. 6, 2006, which is entitled to the right of priority of U.S. Provisional Application No. 60/603,963, filed Aug. 25, 2004.

### BACKGROUND OF THE INVENTION

The present invention relates to a method of controlling termites.

Control of existing termite infestations in structures and prevention of termite invasions is a pervasive and difficult non-agricultural pest control problem. Termites are ubiquitous and forage constantly for new food sources. Wood or wood products in homes provide an inviting target if such foraging termites are undeterred or not removed.

A widely accepted strategy to prevent termite infestation or control existing infestations is treatment of soil under or surrounding a structure. Treatment of the soil is effected by applying a liquid composition containing a termiticide to the soil where the structure touches the soil. By applying a liquid treatment a continuous or contiguous barrier is established wherein foraging termites that encounter it either are repelled or are contacted and receive a dose of termiticide.

Pest control technicians are specifically directed to provide such barriers by applying large amounts of an aqueous termiticidal composition to the soil. Such technicians are warned to create a thorough barrier because foraging subterranean termites can detect gaps between application points and dig through them. Once a food source (that is the structure intended to be protected) is reached, a colony of termites can then be signaled to attack the food source and tunnel through the gap between applications.

Typically, a thorough barrier application of termiticide to a normal house requires diluting the termiticide into from 300 to 1000 liters of water. The applicator chooses the volume of water depending on the type of house needing protection. For example, a house founded on a concrete slab will often require before construction a pretreatment of the soil intended to be under the concrete. When the concrete is poured, curing seals in the termiticide. A serious problem with this technique is that often, despite the best efforts of personnel, treated soil may be removed and concrete placed on an untreated area. Or, there may be mere inadvertent disturbance of soil creating a gap for termite invasion. Depending on the complexity of the slab required and the type of slab (generally a floating slab, monolithic slab, or supported slab), a pest control operator may find it is exceptionally difficult to provide an aqueous termiticidal composition to all parts of the soil under the slab.

Furthermore, post-and-beam construction comprising foundation walls, footings, and wood-joist construction techniques are not immune from termite invasions. As in concrete slab construction, pest control operators may be required to trench around foundation walls, insert rods, and inject under some pressure large amounts of liquid or foamed termiticidal compositions. The amounts of water vary with the size and complexity of the construction of the house, but it is usually inevitable that water containing termiticides will move from a desired treated zone near a foundation wall or pillar and seep into unwanted areas.

Recent innovations in construction techniques provide new challenges in termite control. For example, the use of rigid foam board in concrete pours or as insulation for concrete provides ample opportunity for termite invasion as termites are attracted to forage in such expanded foams. The use of stucco is now often used below the top of the soil. Any gaps between stucco and a foundation material or exterior sheathing material may create prime tunneling gaps for termites to invade. Furthermore, the use of water to apply termiticides to such areas may cause other problems, including microbial or fungal degradation of the building materials themselves.

Application of particulate termiticides is known. In particular, U.S. Pat. No. 6,264,968 describes insecticidal compositions containing an insecticidally active compound combined with an organic natural and/synthetic compounds carrier material that delays degradation and release of the active ingredient. U.S. Pat. No. 6,264,968 requires the use of an organic carrier and does not suggest that inorganic substances can serve as carriers.

### SUMMARY OF THE INVENTION

The present invention provides a method of preventing termite damage to a structure susceptible to termite infestation comprising applying a particulate termiticidal composition comprising (i) at least one termiticidally active ingredient and (ii) an inorganic carrier, in the substantial absence of water at a locus comprising the structure.

### DETAILED DESCRIPTION OF THE INVENTION

By the term “substantial absence of water” is meant that the particulate composition is not applied with water as a carrier or diluent. The composition, however, may possess some water itself due to the way the composition was produced.

The locus may comprise a perimeter or a portion of a perimeter about the structure. Alternatively, the locus may comprise an area substantially defined by a footprint of the structure. The locus may be smaller than the footprint of the structure and/or within the footprint. Alternatively, the locus to be treated may comprise any one or more of a portion of a perimeter of the structure, the footprint of the structure, and an area associated with the structure but outside the perimeter of the structure. The locus may be a spot treatment inside or about a structure which is susceptible to infestation or is infested. The locus may comprise ground where the structure will be built in the future (typically called a preconstruction treatment) or the locus may comprise an existing structure (typically called a post-construction treatment).

The particulate composition is typical of those particulate composition used to control undesired insects or arthropods and is generally acceptable to be used in a non-agricultural setting. The composition is generally non-repellent to termites in particular.

The composition used according to the invention comprises a termiticidal active ingredient bound, either physically or chemically, to an inorganic carrier by a binder or adhesive. The inorganic carrier is typically a solid, such as clay, silicates, silica, or a fertilizer typically used by those of ordinary skill in the art. Suitable solid carriers include, for example, natural ground minerals, such as kaolin, alumina, talc, chalk, quartz, montmorillonite, or diatomaceous earth, and synthetic ground materials, such as highly dispersed silicic acid, aluminum oxide, silicates, calcium phosphates, or calcium hydrogen phosphates. Other materials that may be suitable for the invention include crushed and fractionated natural minerals, such calcites, marbles, pumices, lime or limestone, pumice, sepiolite, or dolomite. In addition to the inorganic carrier, it is also possible to include one or more organic carriers comprising organic ground materials such as sawdust, as well as cellulosic complex granules (such as Biodac® granules), resins, and waxes. Solid compositions can be powders for dusting or for dispersion (wherein the content of active ingredient can be up to 100%) and granules, especially extruded or compacted granules, or granules that have been made by impregnation of a powder (the content of active ingredient in such powders being between about 1 and about 80%).

The compositions of the invention also may comprise wetting agents, surfactants, dispersing agents, or other appropriate adjuvants as selected by those of ordinary skill. Generally, the particulate matter may have an average distribution of diameters of from about 200 to 2000 microns, preferably from about 400 to 1,400 microns. The surface area of a typical particle of the present invention may be from about 200 to 10,000 mm², preferably from 600 to 6500 mm². If the active ingredient has a lower soil mobility, which is gauged by the lipophilicity and water solubility of the active ingredient, then a very low particle size is generally used. In general, dusts or fine granules may be used and thoroughly incorporated in soil to provide a very thorough mixing of soil with active ingredient. A dust may have a mean diameter from 1 to 400 mm and an extremely large surface area, that is, for example, from 5000 to 10,000 mm². In such cases, it may be advantageous to choose an active ingredient that has a much higher vapor pressure as measured under standard conditions.

A substantially water-soluble active ingredient may be advantageously combined with another active ingredient that is either insoluble or sparingly soluble in water to create, over time, two or more zones of treated ground at the locus. Viewed in vertical cross-section, the upper stratum of the treated locus will retain the granules containing the insoluble or sparingly soluble ingredient and having a lower soil mobility and the lower strata will contain the substantially water-soluble active ingredient having a higher soil mobility. In this way, active ingredients of synergistic or additive value may be used, thereby minimizing a termiticidally effective dose at the locus.

Adhesives are generally those adjuvants which have a binding or tacking effect. For example, carboxymethylcelluose, natural or synthetic polymers, polyvinylpyrrolidones, vinylpyrrolidone-styrene copolymers, vinylpyrrolidone-vinylacetate copolymers, polyalkyleneglycols (e.g., diethylene glycol, triethylene glycol, tetraethylene glycol, or pentaethylene glycol), liquid petroleum derivatives, and the like. Inorganic adhesives may be employed, e.g., gypsum. Adhesives are generally present from about 1% to 40% as a weight-weight percentage of the composition, preferably from about 2% to 20%.

When applied to the ground locus, the compositions of the invention typically will release a portion of or all of the active ingredient upon contact with adventitious water in the soil. The composition may be designed to release the active ingredient over time so that with each subsequent rain or other application of water to the ground so treated another dose of active ingredient is released. The person of ordinary skill may design the composition appropriately to effect such a controlled release formulation.

The compositions of the invention will be typically incorporated into the ground at the locus, generally to a depth of from 0 to about 10 inches (i.e., from 0 to about 25 cm) below ground level. It may be more desirable to place the composition in an upper strata of soil dependent on the time of year the composition is applied, the type of termite desired to be controlled, the amount of existing soil moisture and the like. It may be highly advantageous to apply the composition to a depth of from 0 to 5 inches (i.e., from 0 to 13 cm), preferably from 1 to 4 inches (i.e., from 2 to 10 cm), below the ground level to most advantageously place the composition where termites are foraging heavily.

The composition may be applied by any number of ways that a substance may be placed in the ground. The substance may be placed on the ground and incorporated (e.g., raked) into soil or it may be tilled into the ground. A portion of ground is removed to create a void, the removed portion of ground is treated with the termiticidal composition, and the resulting treated portion of ground is returned to the void. Alternatively, a portion of soil is removed to create a void, the void is treated with the termiticidal composition, and the portion of soil is returned to the treated void. For example, a trenching machine may be used to create a shallow trench around a house, the composition deposited in the trench and the trench closed.

Preferably, the termiticidal composition of the invention is substantially undetectable by termites. However, the composition of the invention may be admixed or combined with another adjuvant or termiticidal active ingredient that is detectable by termites.

By the term “termites” is meant any termite that will attack a cellulose product, and termites of the family Rhinotermitidae are preferably controlled by the method of the present invention. Within the family of Rhinotermitidae, the genuses Reticulitermes spp., Heterotermes spp, and Coptotermes spp. are preferably controlled. Most preferably Reticulitermes flavipes, Reticulitermes virginicus, Reticulitermes hageni, Reticulitermes hagenus, Reticulitermes hesperus, Reticulitermes tibialis, Reticulitermes arenicola, Reticulitermes speratus, Reticulitermes santonensis, Reticulitermes lucifugus, Heterotermes aureus, Coptotermes formosanus, Coptotermes havilandi, and Coptotermes acinaciformus are controlled by the method of the invention.

The termiticidal active ingredient generally is mobile in soil. By the term “mobile” is meant that the active ingredient is not tightly bound to soil to the extent that the active ingredient may not be moved by water or moisture away from the area of original placement. For example, the termiticidal active ingredient may have a water solubility from about 100 mg/L to 6000 mg/L at 20° C., preferably from 150 to 1000 mg/L, more preferably from 300 to 600 mg/L, and most preferably from 350 to 600 mg/L.

The termiticidal active ingredient generally has an octanol-water coefficient (K_{oc}) as measured under standard conditions of from 10 to 1000, preferably from 50 to 500, and most preferably from 120 to 250.

The termiticidal active ingredient generally has a DT₅₀ value (that is, the dissipation time required for one-half of the initial quantity or concentration of a pesticide to dissipate from a locus) of from 10 days to 1000 days, preferably from 50 to 1000 days, more preferably from 50 to 500 days.

The termiticidal active ingredient is generally stable in mildly acidic, neutral and mildly basic conditions, that is, generally from pH 4 to 10, preferably from pH 5 to 9. The log P_{ow} (that is, the base−10 log of the octanol-water partition coefficient) is greater than zero (0) at 20° C. Preferably the log P_{ow} is from 0.1 to 1.5, preferably from 0.25 to 1.3.

The termiticidal active ingredient may be an antagonist or agonist of the nicotinergic acetylcholine receptor of an insect. Preferably the termiticidal active ingredient is a compound of formula (I): 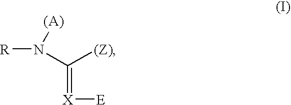
in which
R represents hydrogen, optionally substituted radicals selected from the series consisting of acyl, alkyl, aryl, aralkyl, heteroaryl, and heteroarylalkyl;
A represents a monofunctional group selected from the series consisting of hydrogen, acyl, alkyl, and aryl, or represents a bifunctional group which is linked to the radical Z;
E represents an electron-withdrawing radical;
X represents the radicals —CH═ or ═N—, it being possible for the radical —CH═ (instead of an H-atom) to be linked to the radical Z;
Z represents a monofunctional group from the series alkyl, —O—R, —S—R, 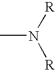
or a bifunctional group which is linked to the radical A or to the radical X when X represents

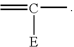

Particularly preferred compounds of the formula (A) are those in which the radicals have the following meaning:
R represents hydrogen or represents optionally substituted radicals selected from the series consisting of acyl, alkyl, aryl, aralkyl, heteroaryl, and heteroarylalkyl.

As acyl radicals there may be mentioned formyl, alkylcarbonyl, arylcarbonyl, alkylsulfonyl, arylsulfonyl, or (alkyl)-(aryl)-phosphoryl, which may in turn be substituted.

As alkyl there may be mentioned C₁₋₁₀-alkyl, especially C₁₋₄-alkyl, specifically methyl, ethyl, i-propyl, or sec- or t-butyl, which may in turn be substituted.

As aryl there may be mentioned phenyl or naphthyl, especially phenyl.

As aralkyl there may be mentioned phenylmethyl or phenethyl.

As heteroaryl there may be mentioned heteroaryl having up to 10 ring atoms and N, O, or S (especially N) as the heteroatoms. Specifically there may be mentioned thienyl, furyl, thiazolyl, imidazolyl, pyridyl, and benzothiazolyl.

As heteroarylalkyl there may be mentioned heteroarylmethyl or heteroarylethyl having up to 6 ring atoms and N, O, or S (especially N) as the heteroatoms.

Substituents for such groups which may be listed by way of example and preference are alkyl having preferably 1 to 4, in particular 1 or 2 carbon atoms, such as methyl, ethyl, n- and i-propyl and n-, i- and t-butyl; alkoxy having preferably 1 to 4, in particular 1 or 2 carbon atoms, such as methoxy, ethoxy, n- and i-propyloxy, and n-, i- and t-butyloxy; alkylthio having preferably 1 to 4, in particular 1 or 2 carbon atoms, such as methylthio, ethylthio, n- and i-propylthio and n-, i- and t-butylthio; halogenoalkyl having preferably 1 to 4, in particular 1 or 2 carbon atoms and preferably 1 to 5, in particular 1 to 3 halogen atoms, the halogen atoms being identical or different and being preferably fluorine, chlorine, or bromine, especially fluorine, such as trifluoromethyl; hydroxyl; halogen, preferably fluorine, chlorine, bromine, and iodine, especially fluorine, chlorine, and bromine; cyano; nitro; amino; monoalkyl- and dialkylamino having preferably 1 to 4, in particular 1 or 2 carbon atoms per alkyl group, such as methylamino, methyl-ethyl-amino, n- and i-propylamino, and methyl-n-butylamino; carboxyl; carbalkoxy having preferably 2 to 4, in particular 2 or 3 carbon atoms, such as carbomethoxy and carboethoxy; sulfo (—SO₃H); alkylsulfonyl having preferably 1 to 4, in particular 1 or 2 carbon atoms, such as methylsulfonyl and ethylsulfonyl; arylsulfonyl having preferably 6 or 10 aryl carbon atoms, such as phenylsulfonyl; and heteroarylamino and heteroarylalkylamino such as chloropyridylamino and chloropyridylmethylamino.
A particularly preferably represents hydrogen and optionally substituted radicals selected from the series consisting of acyl, alkyl, and aryl, which preferably have the meanings given for R. Group A additionally can represent a bifunctional group. There may be mentioned optionally substituted alkylene having 1-4, in particular 1-2 carbon atoms, substituents which may be mentioned being the substituents listed above, and it being possible for the alkylene groups to be interrupted by heteroatoms selected from the series consisting of N, O, and S.
A and Z, together with the atoms to which they are attached, may form a saturated or unsaturated heterocyclic ring. The heterocyclic ring can contain a further 1 or 2 identical or different heteroatoms and/or hetero-groups. Heteroatoms are preferably oxygen, sulfur, or nitrogen, and hetero-groups are preferably N-alkyl, where the alkyl in the N-alkyl group preferably contains 1 to 4, in particular 1 or 2 carbon atoms. As alkyl there may be mentioned methyl, ethyl, n- and i-propyl, and n-, i- and t-butyl. The heterocyclic ring contains 5 to 7, preferably 5 or 6 ring members.

Examples of the heterocyclic ring which may be mentioned are imidazolidine, pyrrolidine, piperidine, piperazine, hexamethyleneimine, hexahydro-1,3,5-triazine, hexahydrooxodiazine, and morpholine, each of which may optionally be substituted preferably by methyl.
E represents an electron-withdrawing radical, in which context particular mention may be made of NO₂, CN, halogenoalkylcarbonyl such as 1- to 5-halogeno-C₁₋₁₄-alkylcarbonyl (especially COCF₃).
X represents —CH═ or —N═.
Z represents optionally substituted radicals alkyl, —OR, —SR, or —NRR, where R and the substituents preferably have the meaning given above.
Z can also form (apart from the above-mentioned ring), together with the atom to which it is attached and with the radical 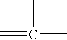
instead of X, a saturated or unsaturated heterocyclic ring. The heterocyclic ring can contain a further 1 or 2 identical or different heteroatoms and/or hetero-groups. The heteroatoms are preferably oxygen, sulfur, or nitrogen, and the hetero-groups N-alkyl, in which case the alkyl in the N-alkyl group preferably contains 1 to 4, in particular 1 or 2 carbon atoms. As alkyl there may be mentioned methyl, ethyl, n- and i-propyl, and n-, i- and t-butyl. The heterocyclic ring contains 5 to 7, preferably 5 or 6 ring members.

Examples of the heterocyclic ring which may be mentioned are pyrrolidine, piperidine, piperazine, hexamethyleneimine, morpholine, and N-methylpiperazine.

As compounds which may be used with very particular preference in accordance with the invention, mention may be made of compounds of the general formulas (II), (III), and (IV): 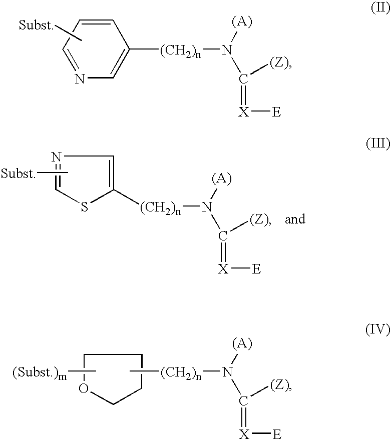
in which
n represents 1 or 2,
m represents 0, 1 or 2,
Subst. represents one of the above-listed substituents, especially halogen, very particularly chlorine, and
   A, Z, X, and E each have the meanings given above.

Specifically, the following compounds may be mentioned:

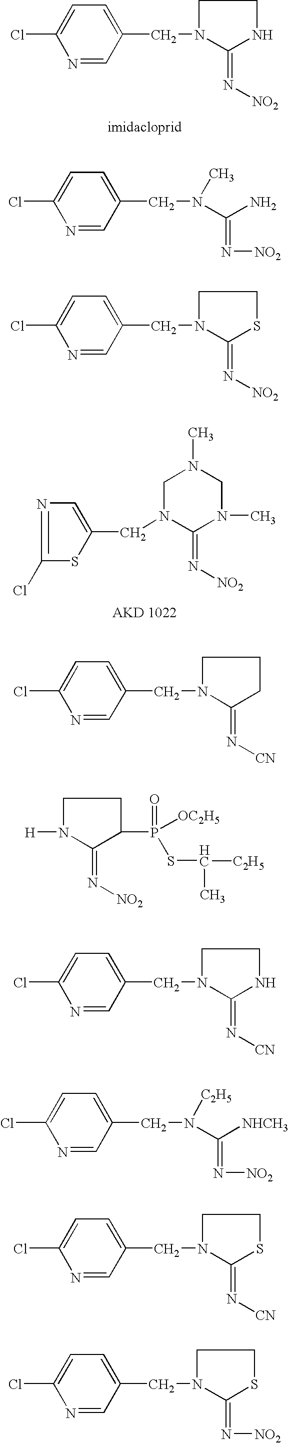

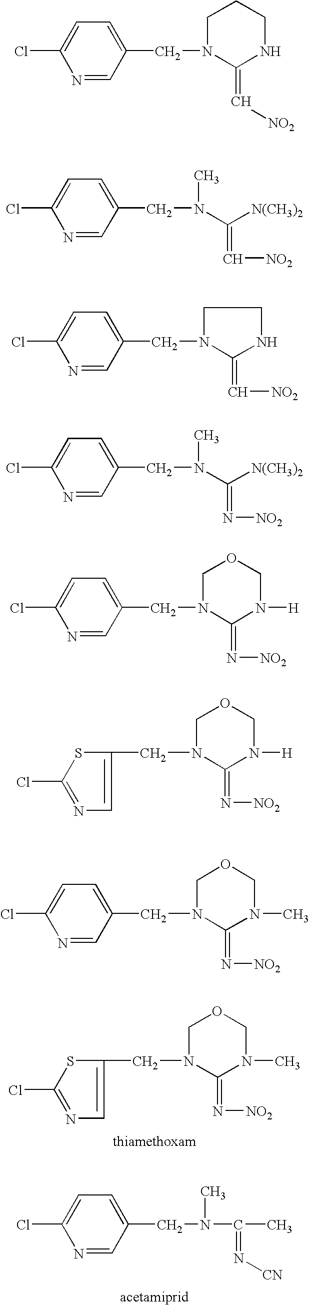

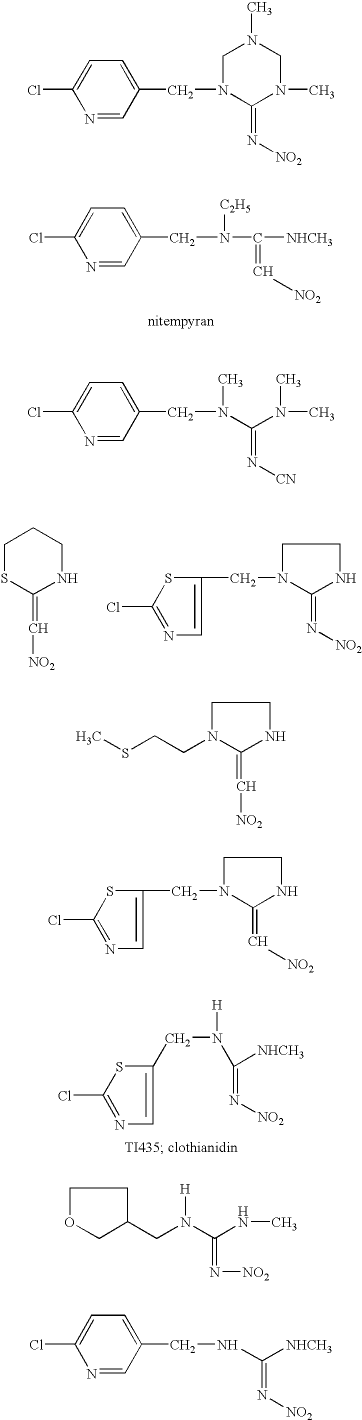

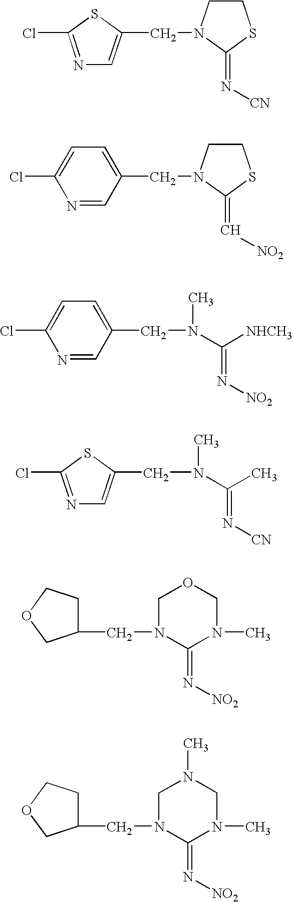

Particular emphasis is given to the compounds

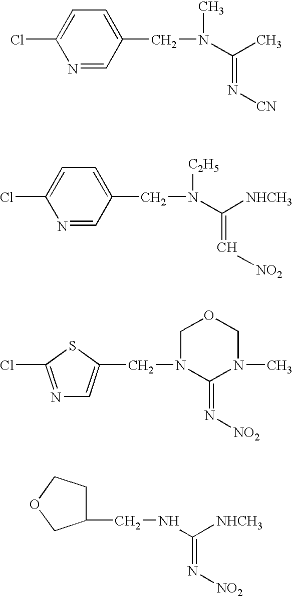

Furthermore, especially particular emphasis is given to the compounds

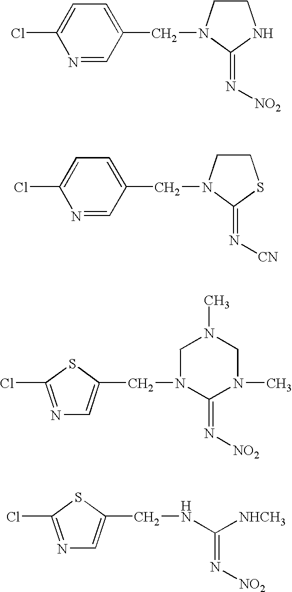

Agonists or antagonists of the nicotinic acetylcholine receptors of insects are known, for example, from European Offenlegungsschriften Nos. 580553, 464830, 428941, 425978, 386565, 383091, 375907, 364844, 315826, 259738, 254859, 235725, 212600, 192060, 163855, 154178, 136636, 303570, 302833, 306696, 189972, 455000, 135956, 471372, and 302389; German Offenlegungsschriften Nos. 3639877 and 3712307; Japanese Offenlegungsschriften Nos. 03220176, 02207083, 63307857, 63287764, 03246283, 049371, 03279359, and 03255072; U.S. Pat. Nos. 5,034,524, 4,948,798, 4,918,086, 5,039,686, and 5,034,404; PCT Applications WO 91/17659 and 91/4965; French Application No. 2611114; and Brazilian Application No. 8803621.

The termiticidal active ingredient can be applied at a rate per unit area that can be substantially less than (e.g., from about 2% to 100% of) the rate required when the termiticidal active ingredient is applied with water.

Imidacloprid is particularly preferred according to the invention is and generally used at a rate from about 0.001 g/ft² to 3 g/ft² (i.e., about 0.001 mg/cm² to 3.2 mg/cm²). When imidacloprid is used as a preconstruction treatment, from about 0.001 to 1 g/ft² (i.e., about 0.001 mg/cm² to 1.1 mg/cm²), preferably from 0.001 to 0.5 mg/ft² (i.e., 0.001 mg/cm² to 0.54 mg/cm²) In post-construction treatment, imidacloprid is used generally from about 0.1 g/ft² to 3 g/ft² (i.e., about 0.1 mg/cm² to 3.2 mg/cm²). A termiticidal composition generally contains from about 0.01% to 5% imidacloprid by weight, preferably from 0.1% to 3% by weight.

Other termiticidal active ingredients that are effective according to the invention include antagonists of ion channels, such as sodium ion (Na⁺) or chloride (Cl⁻) channels, in the insect nervous system. Examples of such ion channel antagonists are arylpyrazoles of formula (II) 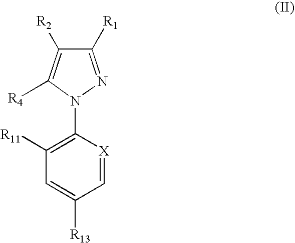
in which
R₁ is CN, methyl, or halogen;
R₂ is S(O)ₙR₃, 4,5-dicyanoimidazole 2-yl, or haloalkyl;
R₃ is alkyl or haloalkyl;
R₄ represents hydrogen, halogen, or a member selected from the group consisting of NR₅R₆, S(O)ₘR₇, C(O)R₇, C(O)O—R₇, alkyl, haloalkyl, OR₈, and —N═C(R₉)(R₁₀);
R₅ and R₆ independently represent hydrogen or an alkyl, haloalkyl, C(O)alkyl, alkoxycarbonyl, or S(O)ᵣCF₃ radical; or R₅ and R₆ can together form a divalent alkylene radical which can be interrupted by one or two divalent heteroatoms, such as oxygen or sulfur;
R₇ represents an alkyl or haloalkyl radical;
R₈ represents an alkyl or haloalkyl radical or hydrogen;
R₉ represents an alkyl radical or hydrogen;
R₁₀ represents a phenyl or heteroaryl group which may optionally be unsubstituted or substituted by one or more halogen atoms or a member selected from the group consisting of OH, —O-alkyl, —S-alkyl, cyano, and alkyl;
R₁₁ and R₁₂ represent, independently of one another, hydrogen, halogen, CN, or NO₂,
R₁₃ represents halogen or a haloalkyl, haloalkoxy, S(O)_{q}CF₃, or SF₅ group,
X represents a trivalent nitrogen atom or a C—R₁₂ radical in which the other three valences of the carbon atom form part of the aromatic ring, and
m, n, q, and r represent, independently of one another, an integer equal to 0, 1, or 2,
   with the proviso that when R₁ is methyl, then either (1) R₃ is haloalkyl, R₄ is NH₂, R₁₁ is Cl, R₁₃ is CF₃, and X is N; or (2) R₂ is 4,5-dicyanoimidazole 2-yl, R₄ is Cl, R₁₁ is Cl, R₁₃ is CF₃, and X is ═C—Cl.

Alkyl groups have generally 1 to 6 carbon atoms.

A preferred group of effective 1-arylpyrazoles of the present invention is that wherein R₁ is CN; R₃ is a haloalkyl radical; R₄ is NH₂; X is C—R₁₂; R₁₁ and R₁₂ represent, independently of one another, a halogen atom; and R₁₃ is a haloalkyl radical.

A most preferred compound is 5-amino 1-(2,6-dichloro 4-trifluoro-methyl phenyl) 4-trifluoromethylsulfinyl 3-cyanopyrazole, hereafter designated as compound (B).

Compounds of formula (II) may be prepared according to known processes, for example, as described in International Patent Publications WO 87/3781, 93/6089, and 94/21606 as well as in European Patent Applications 295117, 403300, 385809, or 679650, German Patent Publication 19511269, and U.S. Pat. Nos. 5,232,940 and 5,236,938 or other processes according to the knowledge of those skilled in the chemical synthesis arts (including Chemical Abstracts and the literature referred to therein). Compositions comprising the compounds of formula (I) may also be prepared according to the teaching of same prior art or similar one. The termiticidal active compositions of the invention may be used in an integrated pest management program (“IPM”) alone or in combination with other active ingredients for termite control.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all percentages are percentages by weight.

### EXAMPLES

### Example 1

Compositions A-C were prepared by diluting into dipropylene glycol Merit® insecticide (active ingredient imidacloprid) as a 75% suspension in water and applying the resulting mixture to bentonite granules or attapugite granules. Table 1 provides the percentages of ingredients in the compositions.

TABLE 1

| | Composition: | | |
|---|---|---|---|
| | A | B | C |
| Merit | 0.67% | 1.33% | 3.33% |
| | (0.5% imidacloprid) | (1% imidacloprid) | (2.5% imidacloprid) |
| Carrier | 94.33% bentonite | 86.67% attapulgite | 84.67% attapulgite |
| Dipropylene | 5% | 12% | 12% |
| glycol | | | |
| Trace | Balance to 100% | Balance to 100% | Balance to 100% |

### Example 2

A 0.25 acre (ca. 0.1 ha) plot was surveyed for termite pressure by installing 6-inch (i.e., 5 cm) wooden stakes in the ground on 3 foot (ca. 1 m) centers. The 294 stakes that were installed were left in place for about 7 months. When inspected for the absence or presence of subterranean termites the following results were obtained:

| | |
|---|---|
| Total number of stakes installed: | 294 |
| Number of stakes attacked by termites: | 287 (97.62%) |
| Number of stakes infested with living termites: | 198 (67.3%) |

Termite species identified from the site were Reticulitermes flavipes, Reticulitermes virginicus, and Reticulitermes hageni, all common indigenous subterranean termites in the southeastern United States. There was sufficient pressure to evaluate under natural conditions the performance of the subject composition's ability to protect wood blocks placed upon the ground from termite attack.

Composition A was applied at each of three rates and compared to an untreated control. Treatments were applied to microplots measuring 17 inches by 17 inches (2.0 sq. ft., or ca. 1,900 cm²). A small hand-powered mechanical hoe with revolving tines was used to incorporate the treatment 1 to 2 inches (i.e., 2.5 to 5 cm) into the soil. A piece of pine sapwood board (ca. 1 inches×6 inches×6 inches (i.e., ca. 2.5 cm×15 cm×15 cm)) was placed in the center of the treated soil and held down by a brick. For each treatment 16 replicated microplots were established. After treatment, annual inspections of wooden blocks determined the ability of indigenous subterranean termites in the area to penetrate the termiticide treated soil and damage the pine blocks. Table 2 provides test results.

TABLE 2

| Application rate⁽¹⁾ | | | | |
|---|---|---|---|---|
| Comp. A | Act. ingred. | | | |
| (oz. per | (g per | Percent of | Percent of plots | Damage |
| sq. ft.) | sq. ft.) | plots attacked | with live termites | rating⁽²⁾ |
| | | One year of field aging | | |
| 5.2 | 0.725 | 25.0% | 0.0% | 9.8 |
| 2.6 | 0.363 | 0.0% | 0.0% | 10.0 |
| 1.3 | 0.181 | 0.0% | 0.0% | 10.0 |
| 0 | — | 100.0% | 100.0% | 5.7 |
| | | Two years of field aging | | |
| 5.2 | 0.725 | 0.0% | 0.0% | 10.0 |
| 2.6 | 0.363 | 6.3% | 0.0% | 9.4 |
| 1.3 | 0.181 | 0.0% | 0.0% | 10.0 |
| 0 | — | 100.0% | 100.0% | 1.9 |

⁽¹⁾Application rates of Composition A of 5.2, 2.6, and 1.3 oz. per sq. ft. correspond to about 0.16, 0.08, and 0.04 g/cm², respectively, and application rates of the imidacloprid active ingredient of 0.725, 0.363, and 0.181 g per sq. ft. correspond to about 0.8, 0.4, and 0.2 mg/cm², respectively.
⁽²⁾Damage rating after ASTM rating “Standard test methods for laboratory evaluation of wood and other cellulosic materials for resistance to termite”. Reference Annual Book of ASTM Standards, Vol. 04.10 - Designation: D 3345-74 (Reapproved 1999)

In each year of inspection, 100% of the unprotected wood blocks were attacked and sustained moderate to heavy feeding damage. Even though a few of the wood blocks in protected plots were attacked, the composition/method prevented termites from becoming established. Termites were not present at the time of inspection and little or no damage was done to the wood blocks. It was unexpectedly found that the treatments were an improvement over aqueous compositions. By use of Composition A, rates of from 0.18 to 0.725 grams of active ingredient per square foot were effective in preventing termites from establishing and/or sustaining attacks on wood blocks protected by soil treatment with the composition/method. From 1.5 to 3.0 grams of imidacloprid per square foot need to be applied in an aqueous composition to achieve equivalent termite control rates.

### Example 3

Soil distributions of the Compositions of Example 1 were studied in the field to determine how effective the subject compositions were at establishing a vertical distribution of active ingredient under natural conditions. The study was duplicated in two soil types, a sandy loam type and a clay type. With respect to the evaluation of the subject compositions, two application methods were compared; a shallow (2 inches, 5 cm) incorporation where surface applied granules were mixed into the top layer of soil, and a deep (4 inches, 10 cm) incorporation, where granules were mixed into soil as a narrow trench was back-filled with excavated soil. Compositions A, B, and C were compared. After being incorporated into the soil, half of the plots received a single irrigation of 1.1 L of water per sq. ft. (i.e., ca. 12 L/m²); and the remaining plots received no irrigation.

These treatment variations were compared against the conventional application method, where a concentrated product was diluted in water, and this dilute preparation was applied at a rate of 3.0 L per sq. ft. (i.e., ca. 32 L/m²) into a trench excavated to a depth of 4 inches (i.e., 10 cm) and back-filled with excavated soil.

All of the treatments in this study were applied at the rate of 1.5 gm of active ingredient per sq. ft. (i.e., 1.6 g/cm²). One month after treatments were established, soil cores were pulled to sample the soil profile to a depth of 12 inches (i.e., 30 cm). These cores were divided into two layers. A shallow, top layer measuring from 0 to 4 inches (i.e., 0 to 10 cm) in depth; this is the zone in soil were all treatments were applied. A deeper, lower layer measuring from 4 to 12 inches (i.e., 10 to 30 cm) in depth; no treatment was applied directly into this zone. The soil core samples were then subjected to soil extraction and analysis to measure the concentration of active ingredient in soil at the various depths in the soil profile. Tables 3 and 4 provide test results for sandy loam and clay, respectively.

TABLE 3
Sandy loam

| | Depth of | | Top layer | Lower layer |
|---|---|---|---|---|
| Treatment | incorporation | Formulation | (0″-4″) | (4″-12″) |
| 3.0 L per sq. ft. | 4″ (10 cm) | 75% WSP | 29.4% | 70.6% |
| (ca. 32 L/m²) | | | | |
| 1.1 L per sq. ft. | 2″ (5 cm) | 0.5 | 80.4% | 19.6% |
| (ca. 12 L/m²) | | | | |
| 1.1 L per sq. ft. | 2″ (5 cm) | 1.0 | 59.4% | 40.6% |
| (ca. 12 L/m²) | | | | |
| 1.1 L per sq. ft. | 2″ (5 cm) | 2.5 | 72.6% | 27.4% |
| (ca. 12 L/m²) | | | | |
| 1.1 L per sq. ft. | 4″ (10 cm) | 0.5 | 56.8% | 43.2% |
| (ca. 12 L/m²) | | | | |
| 1.1 L per sq. ft. | 4″ (10 cm) | 1.0 | 66.3% | 33.7% |
| (ca. 12 L/m²) | | | | |
| 1.1 L per sq. ft. | 4″ (10 cm) | 2.5 | 70.9% | 29.1% |
| (ca. 12 L/m²) | | | | |
| no watering in | 2″ (5 cm) | 0.5 | 65.6% | 34.4% |
| no watering in | 2″ (5 cm) | 1.0 | 53.4% | 46.6% |
| no watering in | 2″ (5 cm) | 2.5 | 69.0% | 31.0% |
| no watering in | 4″ (10 cm) | 0.5 | 78.0% | 22.0% |
| no watering in | 4″ (10 cm) | 1.0 | 54.4% | 45.6% |
| no watering in | 4″ (10 cm) | 2.5 | 38.4% | 61.6% |

TABLE 4
Clay

| | Depth of | | Top layer | Lower layer |
|---|---|---|---|---|
| Treatment | incorporation | Formulation | (0″-4″) | (4″-12″) |
| 3.0 L per sq. ft. | 4″ (10 cm) | 75% WSP | 17.0% | 83.0% |
| (ca. 32 L/m²) | | | | |
| 1.1 L per sq. ft. | 2″ (5 cm) | 0.5 | 100.0% | 0.0% |
| (ca. 12 L/m²) | | | | |
| 1.1 L per sq. ft. | 2″ (5 cm) | 1.0 | 41.6% | 58.4% |
| (ca. 12 L/m²) | | | | |
| 1.1 L per sq. ft. | 2″ (5 cm) | 2.5 | 60.8% | 39.2% |
| (ca. 12 L/m²) | | | | |
| 1.1 L per sq. ft. | 4″ (10 cm) | 0.5 | 76.8% | 23.2% |
| (ca. 12 L/m²) | | | | |
| 1.1 L per sq. ft. | 4″ (10 cm) | 1.0 | 50.3% | 49.7% |
| (ca. 12 L/m²) | | | | |
| 1.1 L per sq. ft. | 4″ (10 cm) | 2.5 | 82.1% | 17.9% |
| (ca. 12 L/m²) | | | | |
| no watering in | 2″ (5 cm) | 0.5 | 100.0% | 0.0% |
| no watering in | 2″ (5 cm) | 1.0 | 26.7% | 73.3% |
| no watering in | 2″ (5 cm) | 2.5 | 55.7% | 44.3% |
| no watering in | 4″ (10 cm) | 0.5 | 95.2% | 4.8% |
| no watering in | 4″ (10 cm) | 1.0 | 31.7% | 68.3% |
| no watering in | 4″ (10 cm) | 2.5 | 51.2% | 48.8% |

Data reported are the percent of total active ingredient recovered found in the upper (0 to 4 in. (i.e., 0 to 10 cm)) and lower (4 to 12 in. (i.e., 10 to 30 cm)) layers of the soil profile. As can be seen in both soil types, with the conventional treatment the large volumes of water applied seemingly drove a majority of the active ingredient (ca. 70% to 80%) into the deeper soil layer. Conversely, in the majority of cases, application of the subject compositions resulted in a conservation of the majority of the applied active ingredient remaining in the upper soil layer. This upper soil layer is where most termite foraging activity is concentrated, and preservation of more active ingredient in the upper strata of soil will lead to improved and extended termite control. However, with the 0.5% formulation in the heavy clay soil, very little to none of the active ingredient ever reached the lower soil layers, meaning that such a low concentration formulation is ill suited to produce a profile of continuously treated-soil to a depth of more than a few inches in a variety of soil types. Even so, with the exception of the 0.5% formulation in heavy clay soil, application of the subject compositions did result in termiticidally effective concentrations of active ingredient reaching the deeper soil layer.

### Example 4

Field trials were conducted at four sites. Composition A was uniformly broadcast over an area measuring from 500 to 1,600 sq. ft. (i.e., 46.5 to 149 m²) without subsequent soil incorporation, and various rates of application were tested. Wooden blocks (15 cm×15 cm×3 cm) were scattered throughout the treated plots and secured to the ground with long spikes. Thereafter, termite attack on the wooden blocks was checked on a monthly basis and recorded. Termite species identified from these sites in the course of these studies were Reticulitermes flavipes, Reticulitermes virginicus, and Reticulitermes hageni, all common indigenous subterranean termites in the southeastern United States. Table 5 provides test results.

TABLE 5

| | Application rates | | | | |
|---|---|---|---|---|---|
| Composition A in | 0 | 29 | 38 | 58 | 116 |
| oz./1000 sq. ft.: | 0 | 8.8 | 11.6 | 17.7 | 35.4 |
| in g/m²: | | | | | |
| Active ingredient | — | 4.0 | 4.9 | 8.1 | 16.2 |
| in mg per sq. ft.: | — | 4.3 | 5.3 | 8.7 | 17.4 |
| in μg/cm²: | | | | | |
| | Blocks | | | | |
| | attacked in | | | | |
| | untreated | % reduction, compared to attacks in | | | |
| | plots | untreated plots | | | |
| 1 month | 1.63 | 85.4% | 95.2% | 100.0% | 88.9% |
| 2 month | 3.10 | 78.5% | 87.5% | 96.8% | 93.7% |
| 3-4 month | 4.25 | 71.8% | 77.0% | 80.1% | 83.4% |

The number of blocks attacked in untreated plots increased with the passage of time, as foraging termites discovered the wood source and recruited nest mates to colonize the resource. In contrast, while some wood blocks established in plots first receiving an application of the subject composition were attacked, the incidence of termite attack was greatly reduced. Even when the subject composition was applied at rates as low as 4 milligrams active ingredient per square foot (i.e., 4.3 μg/cm²), these data indicate that soil treatment with the composition/method was effective in reducing the incidence of termite attack.

### Example 5

Based on Examples 1 to 4, the following product use directions were produced for Composition A of Example 1 in accordance with the Federal Insecticide Fungicide and Rodenticide Act.

General Information:

Composition A of Example 1 is a ready-to-use formulation of imidacloprid intended to kill subterranean termite species of Coptotermes, Heterotermes, Reticulitermes, and Zootermopsis.

This product is formulated on a granulated carrier for perimeter band and/or soil incorporation applications. When applied to soil, precipitation and/or soil moisture cause the active ingredient to release from the granule and establish residues in the top few inches of soil at concentrations that will suppress termite foraging and tunneling and kill foraging termites which may be present at the time of application or shortly thereafter.

Spot treatments with this product can be made, as a temporary control measure, in advance of the date when final treatment of the structure with a conventional soil applied termiticide and/or foundation treatment.

Use Sites:

This product can be applied as directed to bare soils, landscaped areas and turfgrass immediately surrounding commercial and residential structures, as well as other wooden constructions subject to termite attack.

Application:

Perimeter applications: This product can be used as a perimeter band application 3 to 10 feet wide around and adjacent to the structure foundation in commercial and residential areas. To kill subterranean termites foraging near commercial and residential structures, apply this product at a rate of 1.8 lb. (29 oz.) of per 1000 sq. ft. (i.e., 8.8 g/m²). Irrigation of treated areas (not to the point of run-off) will move the active ingredient through the thatch layer in turf, through ground covering and into the underlying soil where termites forage.

Apply this product uniformly over the area being treated with standard granular application equipment; including hand-held spreaders or shaker cans, and wheel-mounted spreaders. Calibrate application equipment prior to use according to the manufacturer's directions. Check frequently to be sure equipment is working properly and distributing granules uniformly and accurately.

Soil Incorporation: Use this product to make spot treatments to kill termites in soil which may be present at the time of application or shortly thereafter.

Incorporate this product in localized areas of soil along the foundation of commercial and residential structures, or in soil adjacent to other threatened wooden constructions. After digging a narrow trench (about 6 inches in width and 6 inches in depth (i.e., about 15×15 cm)), uniformly incorporate ⅙ lb. (3.0 oz.) of this product per linear foot (ca. 280 g per meter) of trench. Mix this product thoroughly with the soil when backfilling the trench. Alternately, incorporate at a rate of ⅓ lb. (5.0 oz.) of this product per sq. ft. of surface (ca. 1.5 kg/m²) to provide a uniform chemical treated zone at critical areas such as around plumbing, bath traps, utility services or wells/cisterns, and around poles or posts, fencing and decking materials, landscape timbers, and similar non-structural wood-to-soil contacts.

Crawl Spaces: To kill subterranean termites constructing shelter tubes between soil and wooden structural timbers in the crawl space, a soil incorporation of this product may be applied. Incorporate at a rate of 0.4 lb. (7.0 oz.) per 10 square feet (ca. 214 g/m²) to provide a uniform treatment area. If necessary, remove cellulose debris from the area to be treated before application. Replace the vapor barrier if this was disturbed during treatment.

### Example 6

A composition of 0.37% imidacloprid on bentonite granules was produced in the manner described in Example 1. Product use directions similar to those of Example 5 were then prepared, with particular utility for subterranean termite species of Reticulitermes.

What is claimed is:

1. A method of preventing termite damage to a structure susceptible to termite infestation comprising applying a particulate termiticidal composition comprising (i) at least one termiticidally active ingredient and (ii) an inorganic carrier, in the substantial absence of water at a locus comprising the structure.

2. The method according to claim 1 wherein the particulate termiticidal composition additionally comprises one or more organic carriers.

3. The method according to claim 1 wherein the locus comprises (i) a perimeter or a portion of a perimeter about the structure, (ii) an area substantially defined by a footprint of the structure, (iii) an area smaller than a footprint of the structure that is entirely or partly within the footprint of the structure, or (iv) combinations thereof.

4. The method according to claim 1 wherein the termiticidally active ingredient comprises a water-soluble active ingredient combined with a different active ingredient that is insoluble or sparingly soluble in water, wherein the solubilities of the ingredients are selected to create, over time, two or more zones of treated ground at the locus in which the upper stratum of the treated locus retains the insoluble or sparingly soluble ingredient and the lower strata contain the substantially water-soluble active ingredient.

5. The method according to claim 1 wherein the termiticidal composition is incorporated into the ground at the locus.

6. The method according to claim 1 wherein the termiticidal composition is applied at the ground locus at a depth of from about 0 to about 25 cm below ground level.

7. The method according to claim 1 wherein at the locus a portion of ground is removed to create a void, the removed portion of ground is treated with the termiticidal composition, and the resulting treated portion of ground is returned to the void.

8. The method according to claim 1 wherein a portion of soil is removed to create a void, the void is treated with the termiticidal composition, and the removed portion of soil is returned to the treated void.

9. The method according to claim 1 wherein the composition is substantially undetectable by termites.

10. The method according to claim 1 wherein the particulate termiticidal composition is not a termite bait.

11. The method according to claim 1 wherein the termiticidal active ingredient has a log P_{ow} from 0.1 to 1.5.

12. The method according to claim 1 wherein the termiticidal active ingredient has a water solubility at 25° C. of from 100 mg/L to 6000 mg/L.

13. The method according to claim 1 wherein the termiticidal active ingredient is an agonist or antagonist of the insecticidal nicotinic acid pathway.

14. The method according to claim 13 wherein the termiticidal active ingredient is imidacloprid, acetamiprid, nitempyran, thiamethoxam, or clothianidin.

15. The method according to claim 1 wherein the termiticidal active ingredient is an antagonist of ion channels in the insect nervous system.

16. The method according to claim 1 wherein the termiticidal active ingredient is applied at a rate per unit area that is from 2% to 100% of the rate required when the termiticidal active ingredient is applied with water.

17. The method according to claim 1 wherein the termiticidal active ingredient is applied as a preconstruction treatment at a rate of from about 0.001 mg/cm² to 1.1 mg/cm².

18. The method according to claim 1 wherein the termiticidal active ingredient is applied as a post-construction treatment at a rate of from about 0.1 mg/cm² to 3.2 mg/cm².

19. The method according to claim 1 wherein the termite is of the family Rhinotermitidae.

20. The method according to claim 1 wherein the termite is of the genus Reticulitermes spp., Heterotermes spp, or Coptotermes spp.

21. The method according to claim 1 wherein the termite is Reticulitermes flavipes, Reticulitermes virginicus, Reticulitermes hageni, Reticulitermes hagenus, Reticulitermes hesperus, Reticulitermes tibialis, Reticulitermes arenicola, Reticulitermes speratus, Reticulitermes santonensis, Reticulitermes lucifugus, Heterotermes aureus, Coptotermes formosanus, Coptotermes havilandi, or Coptotermes acinaciformus.
